(19) United States
(12) Patent Application Publication
(10) Pub. No.: US 2026/0354422 A1
(43) Pub. Date: Nov. 12, 2026

(54) SYSTEM FOR GENERATING A BEVERAGE

(71) Applicant: The Cumulus Coffee Company, New York, NY (US)

(72) Inventors: Demetrio D. ANAYA, Somerville, MA (US); Rachel FOX, Bolton, MA (US); Mesh GELMAN, New York, NY (US); Remi A. GODINEZ, Somerville, MA (US); Steven E. MEYER, Arlington, MA (US); Jessica Dongwen PAN, Highlands Ranch, CO (US); Adam Michael PASKOW, New York, NY (US); Gordon D. ROW, Groton, MA (US); Nathan TYPROWICZ-COHEN, Arlington, MA (US); Zachary H. ZIEPER, Woburn, MA (US)

(21) Appl. No.: 19/135,054

(22) PCT Filed: Dec. 1, 2023
(86) PCT No.: PCT/US2023/082185

§ 371 Date: Jun. 2, 2025

Related U.S. Application Data
(60) Provisional application No. 63/429,935, filed on Dec. 2, 2022.

(51) Int. Cl. A23L 2/54; B67D 1/00; B67D 1/04; B67D 1/08

(52) U.S. Cl. CPC A23L 2/54; B67D 1/0078; B67D 1/0869; B67D 2001/0481; B67D 2210/00104; B67D 2210/00125

(57) ABSTRACT

The present embodiments relate to systems and methods relating to a capsule containing a liquid concentrate and a device capable of creating a gas-infused liquid, such as a nitro-infused cold beverage or iced coffee. The device can include a cold-water tank and a cooling system to chill cold water. The device can also include a gas reservoir including a gas. The device can also include a fluidic capsule connector that includes capsule connector configured to connect to a capsule and establish a pressurized chamber in a cavity of the capsule that is removably connected to the capsule connector, a liquid entrance valve that can configured to provide a stream of cold water and gas to the pressurized chamber. The fluidic capsule connector can also include a dispense port configured to direct a flow of the gas-infused liquid from the pressurized chamber to a dispensing tap.

### CROSS-REFERENCE TO RELATED APPLICATION

This application claims priority to United States Provisional Patent Application No. 63/429,935, titled “AN IMPROVED SYSTEM FOR DISPENSING A BEVERAGE,” filed on Dec. 2, 2022, the entirety of which is hereby incorporated by reference.

### TECHNICAL FIELD

This application relates to the field of generating and dispensing a beverage from a liquid concentrate, and in particular to a removable capsule and a device for creating a cold-brew beverage.

### BACKGROUND

Cold or iced coffee, cold espresso and cold espresso-based beverages are an increasingly popular category of coffee. To date, iced coffee is predominantly created by brewing hot coffee followed by icing. This indirect approach is more time and energy intensive, risks unintended dilution and inherently produces a beverage that has been allowed to age.

Cold brewing, by contrast, is a process in which flavor elements are slowly and selectively extracted at low temperatures, which allows the increased relative extraction of preferred elements and can avoid the extraction of certain other objectionable flavors, such as those contributing to bitterness. Cold brewing, however, may require long preparation time (often 12-24 hours) and special equipment and careful filtering and dilution. Meanwhile, these true cold-brewed beverages have become a popular offering in retail environments but remain largely unavailable to the home consumer.

Cold-brewing typically requires batch-processing, in which a large volume of concentrated extract is produced at one time, and then diluted and served in individual portions. As a result, retail venues do not typically offer a selection of coffee origins, roast profiles, (de)caffeination or strength.

Recent developments in commercial-scale cold brewing have achieved high-quality, high-concentration extracts suitable for long term stable packaging. This creates the possibility of direct preparation of cold brew from a concentrate.

In some examples, the availability of high-concentration cold-brew extract creates a need for accurate chilling and dilution of beverage with water. Existing commercial and retail distribution methods do not allow choice of the many different types of extract. Furthermore, existing nitrogenation processes do not produce the density of foam required for a fully satisfying beverage experience. None of these are available in the consumer kitchen.

### SUMMARY

The present embodiments relate to systems and methods relating to a capsule containing a liquid concentrate and a device capable of creating a gas-infused liquid, such as a nitro-infused cold beverage or iced coffee. The device can include a cold-water tank and a cooling system to chill cold water. The device can also include a gas reservoir including a gas. The device can also include a fluidic capsule connector configured to connect to a capsule and establish a pressurized chamber in a cavity of the capsule that is removably connected to the capsule connector, a liquid entrance port that can configured to provide a stream of cold water to the pressurized chamber and a gas entrance port, or nitro port, to deliver gas to the pressurized chamber. The fluidic capsule connector can also include a liquid dispense valve configured to direct a flow of the gas-infused liquid from the pressurized chamber to a dispensing tap.

In a first example embodiment, a device is provided. The device can include a cold-water tank and a cooling system configured to chill an input amount of water and maintain a temperature of cold water held in the cold-water tank. The device can also include a gas reservoir containing an amount of a gas.

The device can also include a fluidic capsule connector configured to create a gas-infused liquid. The fluidic capsule connector can include a capsule connector configured to connect to a capsule and establish a pressurized chamber in a cavity of the capsule that is removably connected to the capsule connector. The fluidic capsule connector can also include a liquid entrance port connected to the capsule connector and configured to provide a stream of cold water from the cold-water tank and create turbulent conditions in the pressurized chamber. The fluidic capsule connector can also include a gas entrance port connected to the gas reservoir and configured to provide a jet of the gas and introduce a stream of fine bubbles to the pressurized chamber. A gas-infused liquid can be formed by mixing a liquid concentrate from the capsule with the cold water and the gas in the pressurized chamber. The fluidic capsule connector can also include a dispense port configured to direct a flow of the gas-infused liquid from the pressurized chamber to a dispensing tap.

In some instances, the device can also include an input reservoir accessible outside of the device and configured to receive input water. The device can also include a pump configured to pump the input water from the input reservoir to the cold-water tank. The cold-water tank can be insulated with an insulating material. The device can also include one or more temperature sensors disposed in the cold-water tank. The device can also include a heat exchange component extending within the cold-water tank. The heat exchange component can be configured to receive one or more thermoelectric coolers configured to transfer heat from a cold side to a hot side of the heat exchange component.

In some instances, the heat exchange component includes two thermoelectric coolers arranged adjacent to one another.

In some instances, the heat exchange component includes a heat exchange coil cooled by a vapor-compression refrigeration system.

In some instances, the capsule connector comprises a protrusion extending from the capsule connector to break a knockout element in the capsule and create the pressurized chamber between the fluidic capsule connector and the cavity formed in the capsule.

In some instances, the device can also include an air valve disposed adjacent to the gas reservoir. The device can also include a water valve disposed between the gas reservoir and the cold-water tank. Further, at a time of dispensing, the air valve can be closed, and the water valve can be opened to drive a pressurized mixture of gas and cold water into the pressurized chamber via the liquid entrance valve.

In some instances, the fluidic capsule connector further includes a flow restrictor disposed adjacent to the dispense port, the flow restrictor controlling a flow of the gas-infused liquid entering the dispense port.

In some instances, the capsule comprises a main body comprising a cavity and the liquid concentrate in the cavity and a lid portion comprising a hatch with a knockout element disposed on an outer surface of the lid portion. In some instances, the hatch comprises a circular shape or an elliptical shape, and wherein the lid portion is affixed to the main body using a crimp ring or a rolled seam formed around the lid portion.

In another example embodiment, a capsule configured to store a liquid concentrate and create a gas-infused liquid when connected to a fluidic capsule connector providing water and a gas is provided. The capsule can include a main body comprising a substantially cylindrical shape. A cavity can be formed in the main body with a liquid concentrate disposed in the cavity. The capsule can also include a lid portion formed around a flange disposed around an end of the main body, with the flange forming a surface providing a sealing surface. A lid portion can include a hatch on an external surface. The hatch can include a knockout element at least partially extending from the outer surface of the lid portion and allowing to be broken due to a force by a fluidic capsule connector to allow the liquid concentrate to mix with water and a gas to create a gas-infused liquid.

In some instances, a neck portion is disposed between the lid portion and the end of the main body, the neck portion comprising a width that decreases towards the lid portion.

In some instances, the lid portion is affixed to the main body using a crimp ring formed around the lid portion or by a seam-forming operation. In some instances, the lid portion is affixed by a seam-rolling operation.

In some instances, the hatch comprises a raised portion with a height that increases at an angle across a length of the hatch.

In another example embodiment, a system is provided. The system can include a capsule containing a liquid concentrate. The capsule can include a main body comprising a cavity and the liquid concentrate in the cavity and a lid portion comprising a hatch with a knockout element disposed on an outer surface of the lid portion.

The system can also include a device for generating a gas-infused liquid. The device can include a cold-water tank and a cooling system configured to chill an input amount of water and maintain a temperature of cold water held in the cold-water tank. The device can also include a gas reservoir containing an amount of a gas and a fluidic capsule connector configured to create a gas-infused liquid.

The fluidic capsule connector can include a capsule connector configured to connect to the capsule and establish a pressurized chamber in a cavity of the capsule. The fluidic capsule connector can also include a liquid entrance port connected to the capsule connector and configured to provide a stream of cold water from the cold-water tank and a gas entrance port configured to provide a jet of gas from the reservoir to the pressurized chamber. A gas-infused liquid can be formed by mixing a liquid concentrate from the capsule with the cold water and the gas in the pressurized chamber. The fluidic capsule connector can also include a dispense port configured to direct a flow of the gas-infused liquid from the pressurized chamber to a dispensing tap.

In some instances, the system can also include an input reservoir accessible outside of the device and configured to receive input water. The system can also include a pump configured to pump the input water from the input reservoir to the cold-water tank. The cold-water tank can be insulated with an insulating material. The system can also include one or more temperature sensors disposed in the cold-water tank and a heat exchange component extending within the cold-water tank. The heat exchange component can be configured to receive one or more thermoelectric coolers configured to transfer heat from a cold side to a hot side of the heat exchange component.

In some instances, the heat exchange component includes two thermoelectric coolers arranged adjacent to one another.

In some instances, the heat exchange components comprise a sealed refrigerant cooled by a vapor-compression refrigeration system.

In some instances, the capsule connector comprises a protrusion extending from the capsule connector to break a knockout element in the capsule and create the pressurized chamber between the fluidic capsule connector and the cavity formed in the capsule.

In some instances, the system also can include an air valve disposed adjacent to the gas reservoir. The system can also include a water valve disposed between the gas reservoir and the cold-water tank. At a time of dispensing, the air valve can be closed, and the water valve can be opened to drive a pressurized mixture of gas and cold water into the pressurized chamber via the liquid entrance valve.

In some instances, the gas includes nitrogen.

In some instances, the fluidic capsule connector further includes a flow restrictor disposed adjacent to the dispense port, the flow restrictor controlling a flow of the gas-infused liquid entering the dispense port.

In an example embodiment, a method to generate a gas-infused liquid is provided. The method can include obtaining a gas at a gas reservoir. The method can also include obtaining water at a warm water tank. The method can also include obtaining the water at a cold water tank and chilling the water in the cold water tank using a cooling system.

The method can also include obtaining a capsule. The capsule can include a main body comprising a cavity and the liquid concentrate in the cavity and a lid portion comprising a hatch with a knockout element disposed on an outer surface of the lid portion. The lid portion can be affixed to the main body using a crimp ring formed around the lid portion.

The method can also include creating a gas-infused liquid by a fluidic capsule connector. The fluidic capsule connector can include a capsule connector configured to connect to a capsule and establish a pressurized chamber in a cavity of the capsule that is removably connected to the capsule connector. The method can also include providing a stream of cold water from the cold water tank and create turbulent conditions in the pressurized chamber from a liquid entrance port connected to the capsule connector. The method can also include providing a jet of the gas and introduce a stream of fine bubbles to the pressurized chamber by a gas entrance port connected to the gas reservoir. The gas-infused liquid can be formed by mixing a liquid concentrate from the capsule with the cold water and the gas in the pressurized chamber. The method can also include directing a flow of the gas-infused liquid from the pressurized chamber to a dispensing tap via a dispense port.

### BRIEF DESCRIPTION OF THE DRAWINGS

FIG. 1A is a diagram of a beverage dispensing system, showing the major components and subsystems according to some embodiments.

FIG. 1B is an isometric view of a system showing primary exterior features according to some embodiments.

FIG. 2A is an illustration of a beverage concentrate capsule with a crimped lid according to some embodiments.

FIG. 2B is a diagram of another beverage concentrate capsule with a rolled-seam lid according to some embodiments.

FIG. 3A is a diagram of a system for refrigerating a water supply using thermoelectric coolers.

FIG. 3B is a diagram of a system for refrigerating a water using a vapor-compression system according to some embodiments.

FIG. 4 is a diagram of a process for nitrogenating a liquid according to some embodiments.

FIG. 5A is a diagram of a nitrogenation system which acts in a nitrogenation chamber downstream of the dilution of a concentrate according to some embodiments.

FIG. 5B is a diagram of a nitrogenation system in which the nitrogenation occurs within a beverage concentrate capsule according to some embodiments.

FIG. 5C is a diagram of another nitrogenation system in which the nitrogenation occurs within a beverage concentrate capsule according to some embodiments.

FIG. 5D is an illustration the elements of the nitrogenation system according to some embodiments.

FIG. 5E illustrates a first cross-sectioned image depicting the interaction of the capsule and capsule connector according to some embodiments.

FIG. 5F illustrates a second cross-sectioned image depicting the interaction of the capsule and capsule connector according to some embodiments.

FIG. 5G illustrates a third cross-sectioned image depicting the interaction of the capsule and capsule connector according to some embodiments.

FIG. 5H illustrates a fourth cross-sectioned image depicting the interaction of the capsule and capsule connector according to some embodiments.

FIG. 5I illustrates an example isometric view of a portion of the fluidic capsule connector according to some embodiments.

FIG. 5J illustrates an example isometric view of a portion of the dispensing tap according to some embodiments.

FIG. 6 is a schematic of one embodiment of a fluidic system for dispensing a beverage according to some embodiments.

FIG. 7 shows an example networked system which could be used in the systems and methods as described herein.

FIG. 8 shows an example computing device that may be used in practicing example embodiments described herein.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known data structures, timing protocols, software operations, procedures, and components have not been described in detail so as not to unnecessarily obscure aspects of the embodiments of the invention.

### Cold Brew and Nitrogenation

Cold brew coffees may be enhanced by nitrogenation. Nitrogenation (nitro) may refer to the process of infusing a beverage with fine bubbles of a gas (e.g., nitrogen or any other gas) in such a manner that the bubbles remain suspended in the beverage and/or in a layer of foam. This nitro may impart benefits to the beverage: Firstly, but not limited to, the suspended bubbles alter the physical characteristics of the liquid, for example by reducing the density and by changing the viscosity and/or surface tension. This is experienced as mouthfeel which is a preferred characteristic. Secondly, but not limited to, the presence of gases (e.g., nitrogen or air) admixed with the beverage can alter and improve the olfactory perception of the beverage. In some examples, these sensory changes are experienced throughout the drinking of the entire beverage. Thirdly, but not limited to, when bubbles are infused into the beverage in a particular way, the resulting cascade provides a pleasing visual effect and an unambiguous indication that the beverage has been successfully nitrogenated.

Beverages may be nitrogenated primarily by a process similar to carbonation-by dissolving of gases into the liquid. The term carbonation may refer to the dissolving of carbon dioxide (CO2) whereas the term nitrogenation may refer to the dissolving or infusion with nitrogen gas (N2). In the context of this disclosure, the term nitrogen or nitro may be used to refer to either nitrogen gas or plain air. Plain air contains approximately 78% nitrogen and 21% oxygen along with trace amounts of other gases.

Gases may be dissolved into liquids to different degrees, depending on the particular gas and the temperature and pressure of the liquid. Carbon dioxide is highly soluble in water, and thus can release large volumes of gas when de-pressurized. Carbon dioxide also has the tendency to react with water to produce carbonic acid: a tart chemical which lends crispness and a dry sensation to beverages. This is desirable in some beverages such as seltzer, beer or sparkling wines.

Nitrogen, by comparison, has different characteristics. It is less than 1/100^{th} as soluble as CO2 and so can produce a much smaller volume of bubbles when depressurized. Significantly, nitrogen bubbles tend to be smaller than carbon dioxide bubbles. Oxygen is also relatively less soluble in water and is relatively less abundant in air than nitrogen. Oxygen, however, reacts strongly with many constituents of beverages, a process known as oxidation which can rapidly and adversely affect flavors. Oxygen is particularly renowned for creating bitterness in coffee. Nitrogen, however, is chemically inert (we refer here to nitrogen in its diatomic form N2), and it neither acidifies nor oxidizes beverage constituents.

For example, while carbon dioxide is effective and in fact preferred for carbonating certain beverages, nitrogen is particularly suitable for nitrogenating certain other beverages.

Oxygen can be suitable only for limited and short-term nitrogenation. Its limited presence in plain air is not considered problematic.

The characteristics of nitrogen bubbles may affect developing a long-lasting suspension of bubbles and the ensuing creamy layer. This desirable result depends on achieving bubbles of a very small size, for example but not limited to below 50 microns and in some examples below 10 microns. Bubbles this small resist shrinking through re-dissolving into the surrounding liquid and also resist Oswalt ripening, in which small bubbles are absorbed into larger unstable bubbles. Furthermore, these very small bubbles can participate in the well-known cascade effect, wherein their small buoyancy is overcome by the viscous drag of downward flowing liquid.

For these reasons, it is desirable to heavily nitrogenate certain beverages. Nevertheless, the physical-chemistry behavior of nitrogen or air presents a challenge when attempting to infuse sufficient quantities of bubbles into the beverage. In some examples, beverages have been nitrogenated through two commercial processes:
The first example is kegging, in which the beverage is pressurized with nitrogen, refrigerated and stored for a prolonged time. This allows the nitrogen to slowly dissolve into the liquids until it reaches equilibrium. Refrigeration increases the solubility to a significant extent. This kegged beverage can then be dispensed through a tap which depressurizes the beverage, thus allowing the nitrogen to come out of solution, and which agitates and disperses the bubbles. This method is suited for large retail or commercial establishments which have the time, space, and capital to invest in this equipment and process.

The second example is nitro-canning: Another method which again involves pressurizing (with nitrogen) a serving of beverage in a small container, such as a single-serving can. This follows a chemical process similar to kegging but is not dispensed through a tap as in kegged systems. As a result, the degree of nitrogenation is generally reduced.

A beverage container may be equipped with a so-called widget, similar to that used in canned draft beers. This widget device may consist of a hollow chamber with a small orifice. The beverage may be canned along with nitrogen and, when pressurized, forces a small amount of pressurized liquid and gas into the chamber. When the can is opened and thus suddenly depressurized this widget chamber emits a brief jet of gas/liquid which agitates the liquid and causes rapid formation of bubbles. While this method can produce a larger volume of bubbles than simple pressurization with nitrogen, the volume of bubbles is limited to the dissolved nitrogen and the small volume of gas introduced from the chamber.

The abovementioned methods can each have a limit to the amount of nitrogen that can be either dissolved into a beverage (and subsequently released as bubbles) or introduced as bubbles. This generally can result in a volume of bubbles, or a layer of foam, insufficient to produce a complete pleasing drinking experience. By contrast, it can be possible to create and suspend a much larger volume of bubbles into a beverage. The present embodiments describe methods for doing so.

### Overview of System Examples

The present embodiments relate to systems and methods relating to a capsule containing a liquid concentrate and a device capable of mixing the liquid concentrate with cold water and an infusion of gas bubbles to create a gas-infused liquid (or multi-phase gas-liquid fluid), such as a nitro-infused cold beverage or coffee.

The device can include a cold-water tank and a cooling system to chill cold water. In such examples, the cold water may be generated and refrigerated in the system. A cold beverage or cold-water tank can receive and then refrigerate liquid to a cold temperature and hold that liquid at a temperature less than 10 degrees Celsius (C), such as at 1 degree C or 5 degrees C, for example. The water in the cold-water tank can be held close to freezing without being frozen, and a recirculation pump at the cold-water tank can prevent freezing of the water in the cold-water tank.

The device can also include a gas reservoir to hold and dispense a gas for mixing into the liquid as described herein. The device can also include a fluidic capsule connector configured to connect to a disposable or recyclable capsule containing liquid concentrate, and establish a pressurized chamber in a cavity of the capsule. Such a capsule would be able to be inserted by a user into the system and the capsule connector may connect to it where a liquid entrance port can be configured to provide a stream of cold water into the pressurized chamber, and a gas entrance port, or nitro port, can be configured to provide a jet of gas into the pressurized chamber. The fluidic capsule connector can also include a dispense port configured to direct a flow of the gas-infused liquid from the pressurized chamber out of it and to a dispensing tap.

### Hardware System Examples

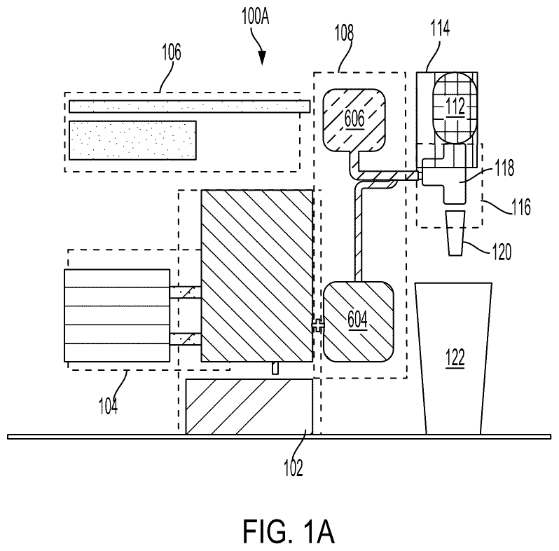

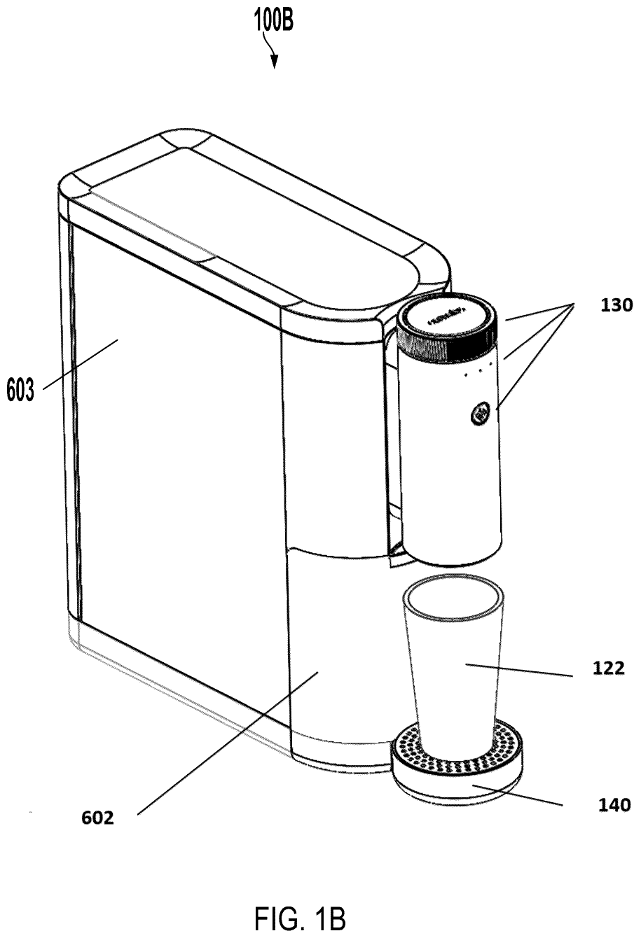

FIG. 1A depicts a general overview of an example device 100A for dispensing a cold or cold, nitrogenated beverage as described herein. In the example, a water supply system 102 may consist of one or more reservoirs coupled to a cooling system 104 which can refrigerate or chill and maintain a supply of water (or any other liquid) at a low temperature ready for dispensing. In some examples, the refrigerator system may be configured to chill water down to near 0 degrees C. In some examples, the refrigerator system may be configured to chill water down to 5 degrees C. In some examples, the refrigerator system may be configured to chill water down to 1 degree C. In some examples, the refrigeration reservoir includes a recirculation pump that keeps the water in the reservoir moving to reduce the risk of freezing.

As shown in the example, an electrical power and control system 106 may provide power to components of the device 100A, such as pumps, valves, sensors, indicators, etc. The control electronics part of the control system 106 can provide control of the system components allow an interface to input/output data to a user. Wiring or connections for all of the different power and control supplies are not depicted in FIG. 1A but would follow routes within the system for electrical connectivity to operate and control the system as described herein.

As described herein, the system is configured to accept a disposable or otherwise removable capsule containing concentrated liquid and generate the gas-infused liquid beverage. As shown in FIG. 1A, a capsule 112 containing liquid concentrate may be inserted into a capsule holder or capsule carrier 114. The capsule holder may be a component of a mechanism suitable to provide a high clamping force to accomplish the fluidic seal.

Once inserted, a nitrogenation system 116 can establish a fluid connection with the capsule 112 via a mechanical and fluidic capsule connector 118. Once the connection is made between the system and the capsule, the cold water and jet of gas can be injected or inserted into the capsule as described herein and then dispensed. For example, the gas injection port may connect the gas reservoir 606 to the capsule connector 118. When the gas is released as described herein, it may produce an abundance of fine bubbles, such as bubbles with a diameter of less than 50 microns (e.g., 10 microns, 20 microns or smaller) via gas reservoir 606, and into the capsule 112. Further,

a mechanical and fluidic capsule connector 118 may establish a fluid connection with the capsule. A fluidic system 108 may deliver pressurized, chilled water to the capsule as described. There, the nitrogenation system 116 can produce an abundance of fine bubbles and dispenses a beverage through a dispensing tap 120 into a drinking vessel 122.

FIG. 1B is an isometric view of an example system 100B showing primary exterior features of the device as described herein. Elements of a user interface 130, for example illuminated indicators, buttons, knobs, audible indicators and graphics, etc., may be located on a visible, accessible and prominent location, for example on a front surface of a system. One example may be a button that when pressed, sends a command to the control system to begin activation of the system to mix and dispense a gas-infused liquid as described herein. When a beverage is to be dispensed a beverage vessel 122 may be placed on a similar location, such as the front of a system. This location can allow easy access to a user placing a vessel and removing a dispensed beverage and may allow a user to observe the progress of a dispensing operation.

A drip tray 140 may be provided to collect excess liquids produced by the beverage dispensing operation described herein, for example in purging system components of residual liquids, or spills inadvertently caused by a user. The drip tray may be positioned in a location conducive to collecting liquids, for example by allowing drainage towards the bottom of system 100A-B, and in a location accessible to a user, for example at the front of a system. This can readily allow monitoring of a drip tray and easy removal and replacement of a drip tray for cleaning.

A warm water or room temperature reservoir 602 may be positioned in an accessible location, for example accessible from the front of a system. This can allow a user access to said reservoir for the purpose of providing a fresh water supply, without interference from adjacent objects. This can also allow for locating a warm water or room temperature water reservoir 602 in a prominent position, such as the front of a system, is that the status (e.g., the level of fill) of the reservoir may be easily visible to a user.

In some embodiments, the system may have proportions that are significantly narrow in one dimension, for example in width. This width may be 125 mm or 150 mm or 175 mm or another dimension. This can allow a system to occupy a small footprint, e.g., on a countertop.

The body of the system 603 may house the internal components as described in FIG. 1A.

### Capsule Examples

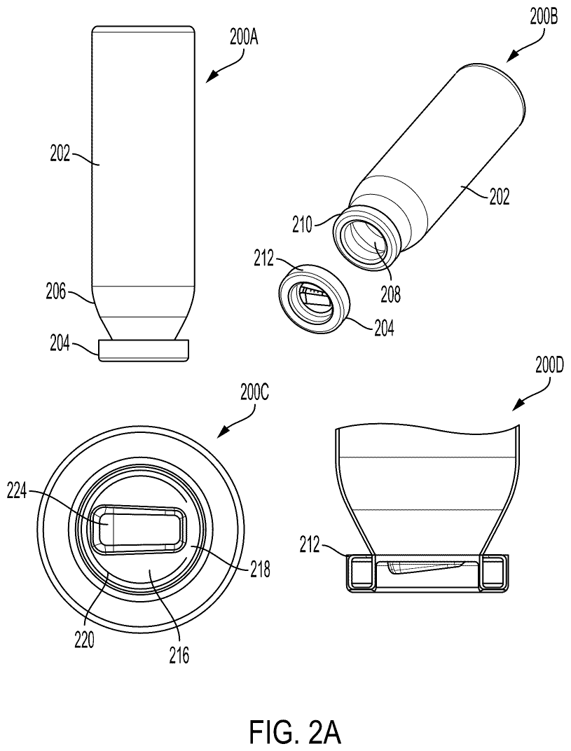

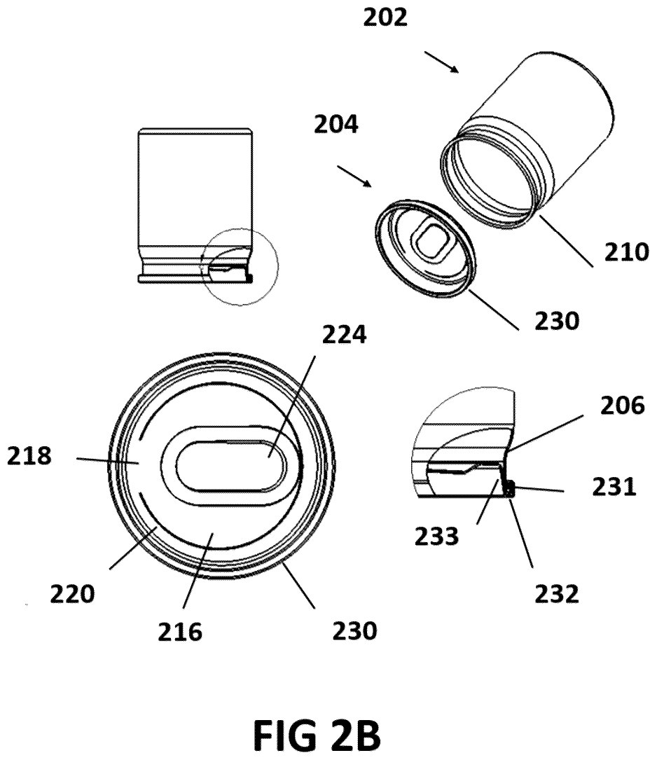

As described herein, a separate capsule (e.g., 112 in FIG. 1A) can be deposited, inserted, or otherwise introduced into the nitrogenation system 116 to provide a liquid concentrate used to generate the gas-infused beverage. FIGS. 2A and 2B show example views of a capsule suited for dispensing a beverage derived from a concentrated liquid. Such relative dimensions shown in the examples of FIGS. 2A and 2B are merely illustrative and could be adapted to the system, for example, length, width, diameter of the capsule could vary depending on the amount of liquid concentrate is required and the volume of the mixing chamber that is desired.

Such example capsules may contain and preserve the liquid contents during transportation and prolonged storage, establish robust fluid connections with the dispensing device, and withstand the dispensing pressure. This capsule may accommodate a variety of beverage types, including nitrogenated beverages, non-nitrogenated beverages and different volumes and concentrations.

For instance, in FIG. 2A, a first view of a capsule 200A can include a main body 202 and a lid portion 204. The capsule 200 can also include an angled portion 206 or neck portion between the main body 202 and lid portion 204. In some instances, the angled portion 206 can be curved inward and have a smaller diameter than the main body 202 to manipulate fluid concentration and movement through the capsule.

The capsule may take various shapes or proportions (e.g., diameter and length) provided it maintains sufficient internal volume. This volume may be selected to contain a sufficient quantity of liquid concentrate and empty space (head space) as preferred for the nitrogenation process described herein. In some examples, the capsule may be lined with a coating to aid in the preservation of the contents. The internal shape may be shaped to permit draining of liquids when in operation.

The capsule may have particular shape and dimensions to provide the necessary capacity and to fit within the dispensing and mixing device. For example, the body 202 diameter may be 30 mm; the length may be 40 mm; the lip 210 diameter may be 30 mm; the narrowed neck 206 may have a diameter of 27 mm or 28 mm. These dimensions may be formed with particularly close tolerance (for example, but not limited to, 0.1 mm or 0.2 mm or another number) to aid in the alignment of the capsule to the nitrogenation system or to prevent misuse.

The capsule may be formed of aluminum, other metals, plastics, resins, composites, organic materials, papers, ceramics or of another material alone or in combination. An example advantage of an aluminum capsule can be its suitability for recycling.

The main body 202 featuring a chamber of suitable volume (for example but not limited to, 15 mL or 20 mL or 25 mL or 30 mL or another volume). The main body 202 may be lined or coated to aid in preserving the liquid contents. Further, as shown in view 200B, an opening 208 can be formed within the main body 202 and enclosed via the lid portion 204.

As shown in view 200B, the capsule may be fitted with a lid 204 which forms a liquid-tight seal against the main body 202. This lid 204 may be made of a recyclable material such as aluminum or plastic. The lid 204 may be attached to the capsule by, for example but not limited to, crimping, by welding or by bonding or by another method of fastening. The lid 204 may be lined or coated to aid in making a seal and in preserving the liquid contents. In one example the lid portion 204 may have an external crimp 212 disposed to fit around the flange 210 of the main body 202. This crimp 212 may be crimped or rolled over to fasten the lid 204 to the main body 202. Such crimping may be made during production of the capsule after filling with whatever liquid concentrate is desired such as but not limited to concentrated coffee, juice, tea, soft drink, sports drink, alcohol, or any other liquid concentrate.

The view 200C as shown in FIG. 2A can show a top portion of a lid 204. In an example embodiment, the lid 204 includes a thinned or breakable knockout element, or hatch 216, which may be broken by an applied force. This hatch may be designed to be opened with a relatively low and/or predictable force such as that applied by the system when inserted as described herein. An example advantage of this knockout-style hatch is that it can maintain integrity of the parent material and thus the integrity of the capsule. This hatch may be designed with a hinge feature 218 which has the function of controlling the way in which the hatch opens and preventing the hatch from becoming dislodged when it could obstruct the flow of fluids, interfere with mechanisms or potentially present a hazard to users. Keeping the hatch connected can also ensure that it is recycled with the remainder of the capsule.

The hatch may be formed by stamping a thinned-out section, in the form of a groove 220, around a preferred outline. This outline may be in the form of a circle or a partial circle or another shape which will permit entrance of the capsule connector. The thinned-out section functions by locally weakening the material and thereby reducing the force required to open the hatch. Unlike the similar groove in so-called easy-open lids, this groove may have sufficient strength to resist manual opening, and thus require a specific mechanism to puncture it.

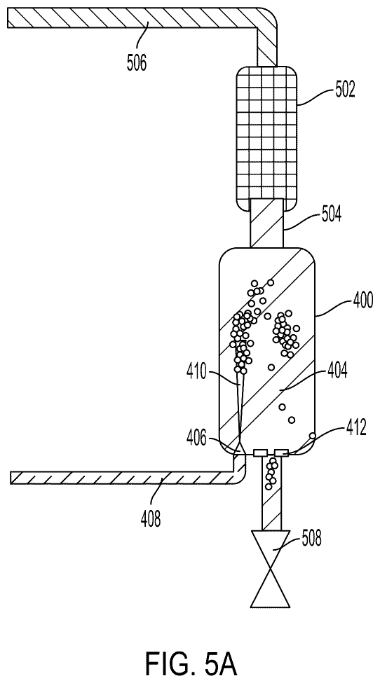

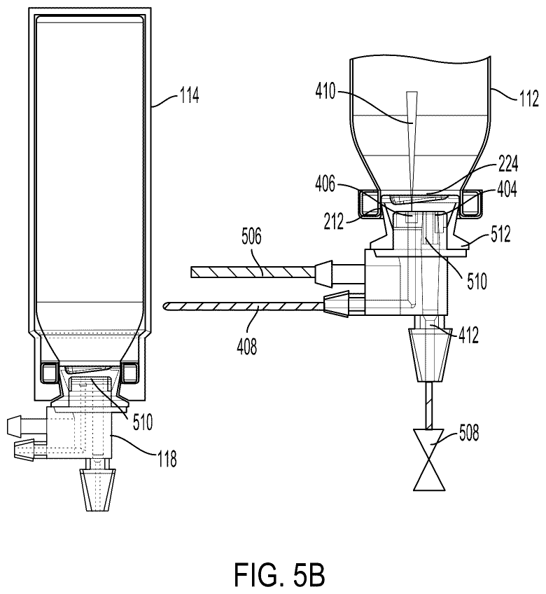

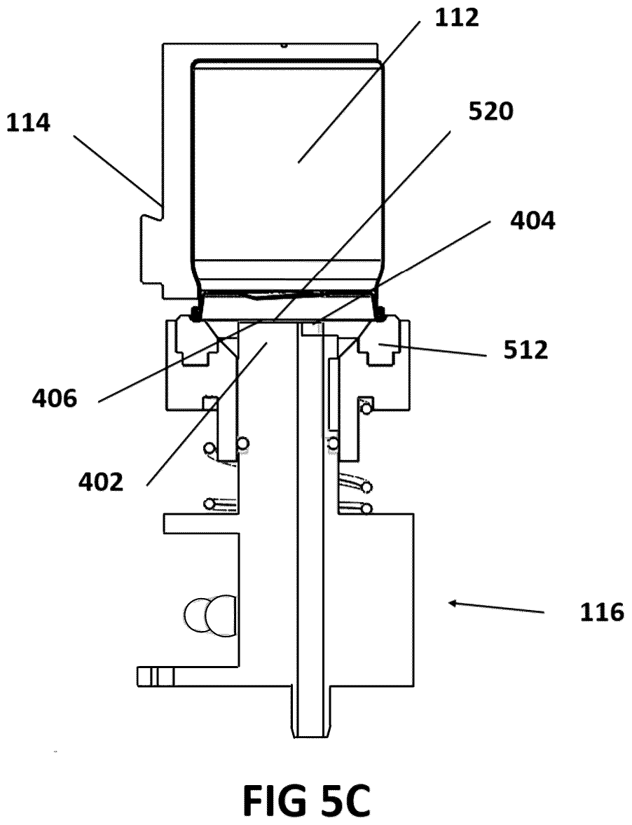

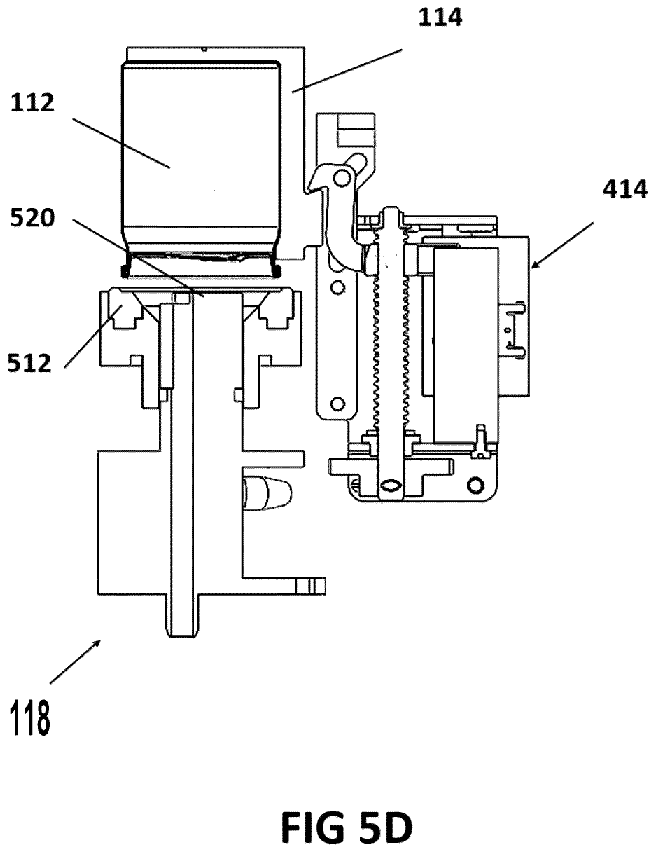

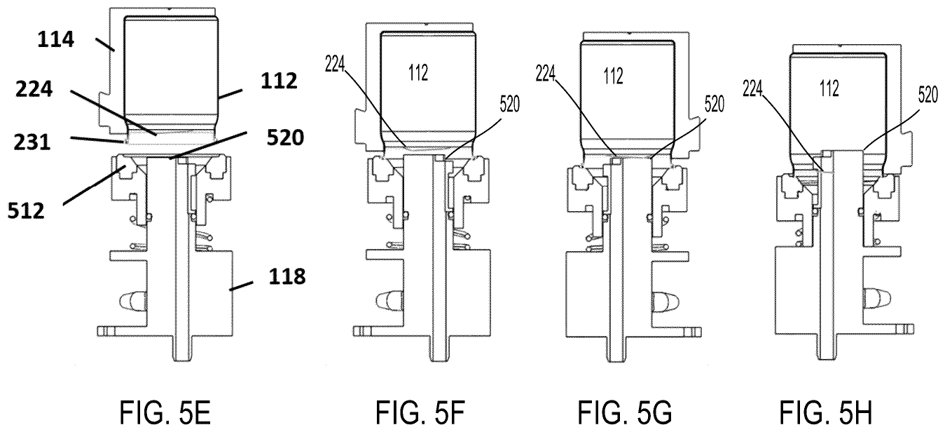

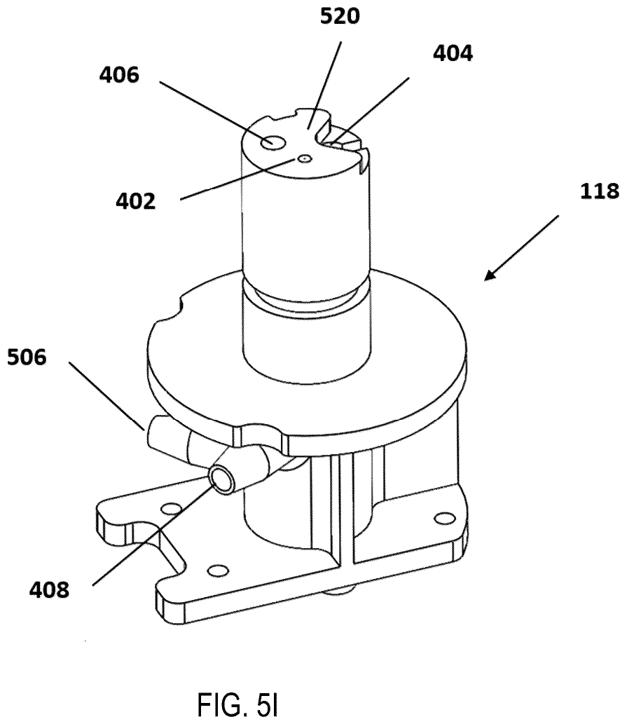

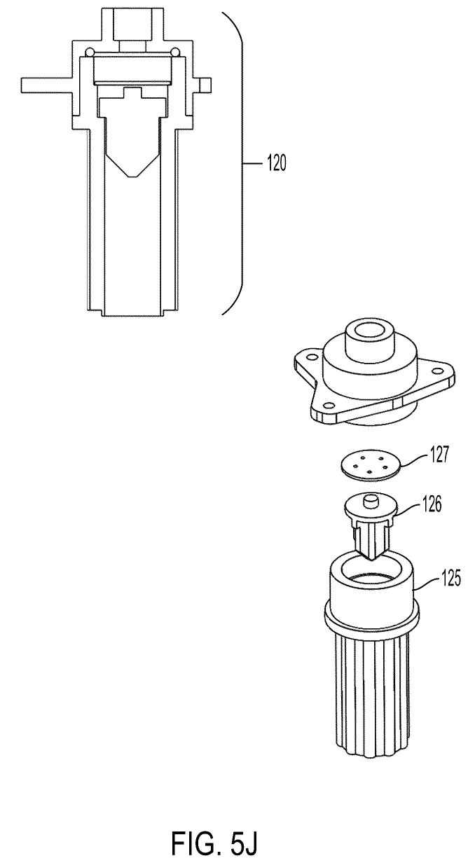

The hatch may include a raised or formed section 224 which has the purpose of defining the point of contact with a capsule connector and concentrating force or stress on the hatch so that the groove 220 fails in an intended location or manner (See FIGS. 5C and 5E-5H). The height of this force concentrator 224 may determine the timing of the contact with the fluidic capsule connector 116 when the two are forced together to open the hatch and connect the capsule connector to the capsule in operation as disclosed herein.

The force concentrator 224 may have an outline suited to stiffen the hatch such that the hatch may maintain its shape during puncturing and thus swing open under the force of the fluid connector. For example, the force concentrator 224 may be in the shape that is oblong, oval, or otherwise long. The protruding surface of force concentrator 224 may have a height that lies at an angle relative to the otherwise flat surface of hatch 216. This may have the advantage of causing a penetrating object, such as the capsule connector to reliably contact the force concentrator at the same location regardless of the orientation of capsule 112 about its axis. The hinge 218 may be located such that the hatch 216 swings up and into the capsule body 202 and clear of the inserted capsule connector (shown below) when punctured. For example, the hinge 218 may act about a line which lies outside the diameter of the engaging portion of the capsule connector. The score groove 220 may be a circular or semi-circular shape with diameter of 20 mm or 21 mm or 22 mm or another shape or size within the top of the lid. The groove may have a depth resulting in a residual material thickness of 0.06 mm or 0.08 mm or 0.1 mm, or another thickness to achieve the failure force described herein.

Other methods of puncturing a capsule may be utilized, for example a membrane pierced by the capsule connector, or a separate piece pressed into the capsule opening 208.

The form of the capsule body 202 may be any shape, for example but not limited to, generally cylindrical. Capsule bodies 202 may be generally cylindrical or axisymmetric in shape or may have any kind of cross-sectional shape desired such as but not limited to a square cross section, elliptical cross section, octagonal cross section, or other geometrical shaped cross section as desired. This example may have the advantage of withstanding internal pressures, or external forces, using a minimum of material. This form may also be useful for dense packing of capsules for transportation and storage. This form may also be useful for handling in typical liquid filling machinery. An axisymmetric form such as a cylinder can have the advantage of not requiring a specific orientation when inserted into a dispensing device. Any orientation of the capsule in regards to the connector when driven together may be arranged, such that a user would not have to worry about spinning the capsule to line up correctly. Any angle of the hinge and force concentrator would still work in operation with the connector as shown in FIGS. 5C and 5E-5H.

FIG. 2B depicts another capsule 112 with a different aspect ratio of height and diameter and which may be assembled by a rolled seam method. Similar to the capsule of FIG. 2A, the capsule may comprise a main body 202 and a lid portion 204. The main body may be substantially cylindrical and comprise a neck 206 with reduced diameter. Similarly, the lid portion 204 may comprise a recessed section with a hatch 216, raised force concentrator 224, score line 220 and hinge 218 as described. This lid portion may comprise a formed flange 230 disposed to fit over the flange 210 of the main body. These flanges 210 and 230 may be configured to be rolled into an interlocking seam 231 to produce an airtight and sanitary seal. A sealing compound may be provided to further ensure a sanitary seal. The resulting seam 231 can provide smooth and continuous surface such as rim 232 and internal diameter 233 suitable for use in forming a seal.

### Cold Water Refrigeration System Examples

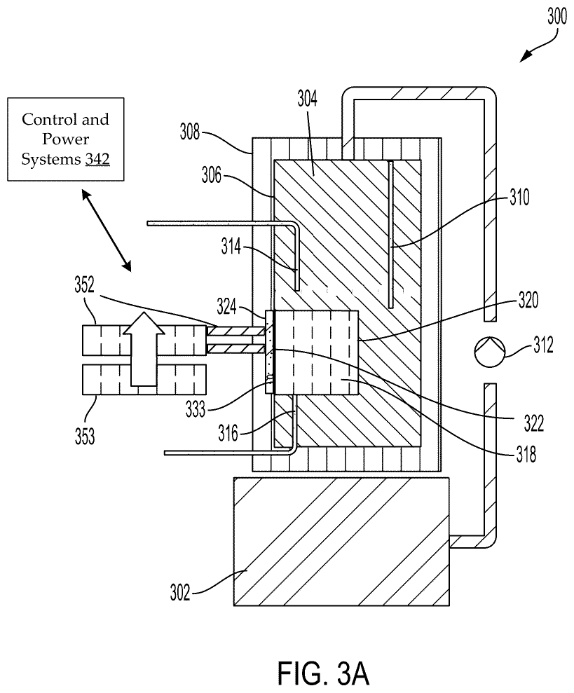

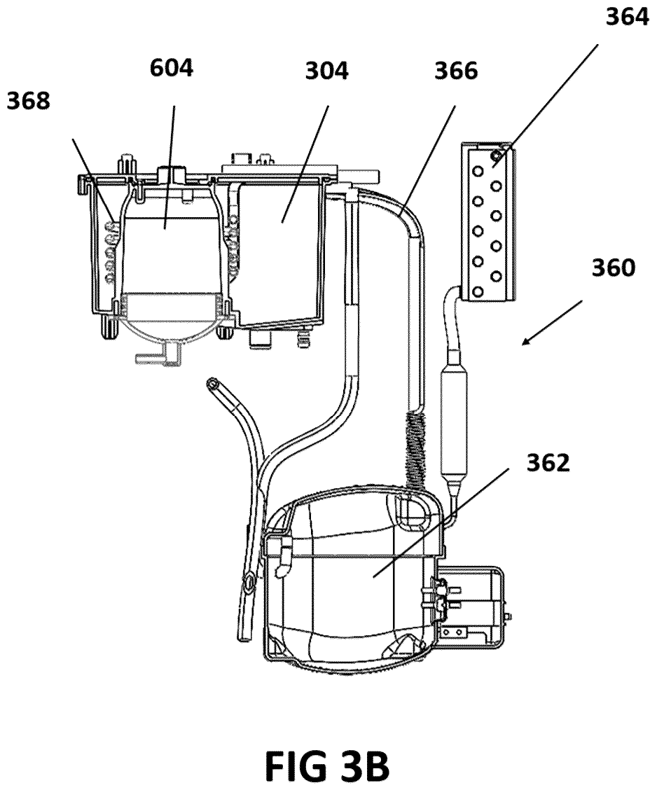

As described above, the system is configured to inject both a jet of gas but also a stream of cold water into the capsule chamber for mixing the gas-infused liquid. As shown in FIG. 1A the cooling system 104 can cool or chill or otherwise refrigerate water (or any other liquid) provided in a reservoir for use in the systems and methods described herein. FIGS. 3A and 3B are example diagrams of a system 300 for efficiently creating and maintaining a supply of cold water in the other systems described herein.

For some types of dispensed beverages, it may be useful to maintain a supply of water at a readily chilled temperature (for example, just above the freezing point). This may present challenges in terms of the maximum power required to initially chill a supply of water, and also in the steady-state power required to maintain the chilled water in readiness. Refrigeration systems are typically bulky, inefficient and noisy, which conflicts with the need for a compact, quiet and energy-efficient device.

A warm or room temperature water reservoir 302 can be configured to be accessible to the outside of the dispensing device and can be filled by a user. In this context, warm or room temperature water can refer to water that is added by a user and which temperature is not controlled. Such water can include tap water at the temperature of a municipal water supply (for example, 15 degrees C) or water at room temperature (for example, 22 degrees C). As shown in FIG. 3A, a cold reservoir 304 may consist of a closed chamber 306 surrounded by insulation 308. This cold reservoir 304 may be sized to hold a volume of water sufficient to dispense a limited number of 355 mL or 235 mL beverages, such as 1 or 2 or perhaps 3 or 4 servings. In some examples, the reservoir may be large enough to dispense even more beverages such as 10 or 15 beverages of 355 mL. Any example reservoir could be connected to the system.

Still referring to FIG. 3A, one or more water level sensors 310 may detect that the cold-water level is sufficient to dispense a beverage using a float sensor, liquid sensor or other sensor placed appropriately at a predetermined fill line. Such a sensor may be in communication with the command system and/or an indicator on the system user interface to indicate that the water is the programmed temperature. If additional water is required, pump 312 may move from the warm reservoir 302 to the cold reservoir 304. Alternately, warm water may flow by gravity into the cold reservoir when released by a valve. Water temperature sensor 314 may be configured to detect the temperature at the warmest point in the cold reservoir and can be used to signal readiness of a portion of water. In some instances, another temperature sensor 316 may be configured to monitor the temperature at the coldest location and can be used to control the thermoelectric cooling system. When multiple beverages are to be dispensed in rapid succession, it may be desirable to maintain the lowest temperature possible in this cold reservoir even as it is replenished from the warm water supply. In some embodiments, both the cold reservoir temperature and supply can be monitored, and (warm) water added gradually, in an amount marginally sufficient to supply a subsequent beverage. In this manner, a prolonged cool-down time of a newly refilled cold reservoir can be avoided.

A heat exchange component, that may be referred to as a cold sink 318 may be located inside the cold reservoir. When in use, the cold sink 318 may interface with the water in the cold reservoir 304. The cold sink 318 may include numerous features to maximize its surface area including but not limited to fins 320 that contact and are exposed to any water in the cold reservoir 304 and a base 322 penetrating or otherwise extending through or around the insulated wall of the reservoir 308. The cold sink 318 may be constructed of a highly conductive material such as aluminum or copper, and may be designed with dimensions, e.g. fin length and thickness, to conduct heat from the water to the cold sink base 322 with maximum efficiency. For example, the fins may be very long in comparison to their thickness, to permit deep penetration into the volume of water, create large surface area for convective heat transfer and efficiently conduct heat to the base 322.

The exterior face of the cold sink base may be configured to receive one or more thermoelectric coolers (TEC) 333. A thermoelectric cooler (TEC) may also be called a Peltier cooler, heater, Peltier device, Peltier heat pump, solid state refrigerator, thermoelectric battery or thermoelectric heat pump is a solid-state active heat pump which transfers heat from one side of the device to the other, with consumption of electrical energy, depending on the direction of the current. These solid-state device function by transferring heat between parallel faces when electrically energized and use a separate means to move this heat away from the “hot” side of the device. Thermoelectric cooler(s) 333 are disposed between cold sink 318 and a thermal distribution plate 324, such that the cold sink 318 lies within the cold insulated cold reservoir and the thermal distribution plate 324 lies outside of the insulated reservoir. Thermal distribution plate 324 is further coupled to heat pipes which are part of a radiator 352. In this arrangement, heat is conducted from the hot side of the thermoelectric cooler 333 to the radiator. One or more fans 353 circulate air through radiator 352 to exhaust the extracted heat to the local environment. The outer hot surface of the TEC can be mated to a heat-exchanger 352 for example a heat-pipe based radiator system.

The cold sink 320 may be used to transfer heat from the relatively warmer water 302 to the relatively colder TEC 333. The cold sink 320 may be configured for utilizing convection currents in a large volume of the water and conduct heat to a small footprint of the TEC 333. In the example shown, the cold sink may accommodate a single TEC 333. In another example, alone or in combination, the cold sink 320 may accommodate twin TEC 333 modules arranged beside each other. This has the advantage of permitting more than one TEC to operate, each at their most efficient level of operation. The TEC 333 may be configured to transfer heat from a cold side 304 to a hot side. The particular operating characteristics of a TEC permit highest efficiency at a reduced operating current.

Initially chilling the full volume of water in the cold reservoir 304 may require a large amount of cooling power, which can result in poor TEC 333 efficiency, whereas subsequent maintenance of the low temperature, or restoring of the low temperature after additional water has been added, may require lower power and hence can be accomplished at greater TEC efficiently. For this reason, it may be advantageous to incorporate more than one TEC 333 into the cold sink 320. These multiple TECs may be used when transferring maximum thermal power, and then just one TEC 333 can be active when transferring low power. This configuration may result in a more versatile system capable of powerful performance and excellent energy efficiency.

In another preferred embodiment, the cold-water reservoir 304 may be partitioned vertically into more than one chamber, for example, two chambers. These vertically partitioned chambers may each be fitted with a cold sink and a corresponding TEC. This may have the advantage of allowing the cooling system to expeditiously cool a smaller volume of water (for example, enough for a single serving of a beverage) without needing the time to cool the entire reservoir. When this first vertically partitioned chamber is depleted, the cooling system can be controlled to cool the second chamber, and thus can cool this subsequent portion of water in a shorter time.

As shown in the example of FIG. 3A, water from the warm reservoir 302 may be transferred to the cold reservoir 304, as needed, by a pump 312. Alternatively, the warm water reservoir may be an external reservoir and may be positioned above the cold reservoir allowing water to be transferred by opening a valve and allowing flow by gravity. A control system in conjunction with water level sensors and temperature sensors may transfer water to replenish the cold-water supply.

A water pump 312 may be positioned to draw water from the cold reservoir into the mixing system during dispensing of a beverage as described herein.

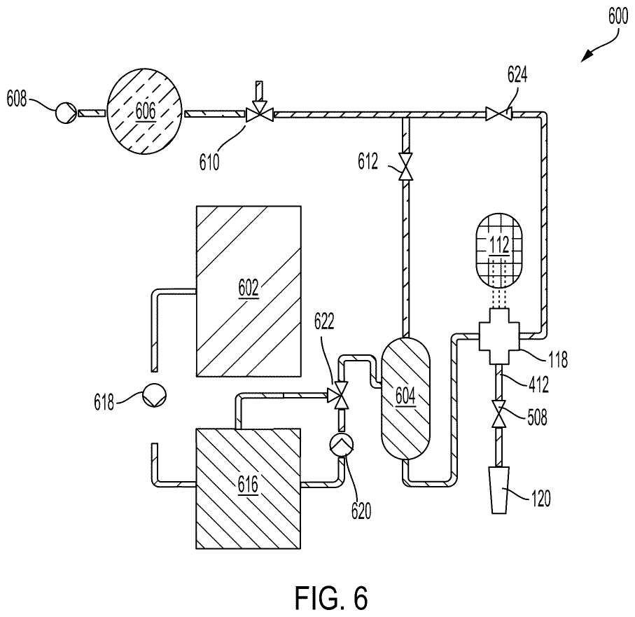

FIG. 3B is a diagram of another example embodiment in which the cold reservoir 304 may be cooled by a vapor-compression refrigeration system 360. In this embodiment, the cold reservoir 304 is cooled by direct heat exchange with a refrigerant. The refrigerant liquid may be cooled by a compressor 362, and then may pass through tubing 366 to a coil 368 which may be immersed in the cold reservoir 304. In some examples, the coil 368 may be a coil of metal tubing such as but not limited to copper, steel, aluminum or alloys of copper or aluminum or steel. The material of the coil 368 may be heat conductive. In such a way, the cold refrigerant liquid moves through the coil of tubing 368 submerged in water that is to be cooled by the system. In some example embodiments, the coil of tubing 368 and may further be wrapped in close contact with the measurement chamber 604 which itself may be immersed in the cold reservoir, described in more detail in FIG. 6.

The extracted heat from this arrangement and compressor 362 may be exhausted to the local environment through a radiator 364. This cooling system may be equipped with temperature sensors and liquid level sensors as described above. This embodiment may have the advantage of permitting the cooling mechanism to be fully shut down, for example to minimize latent power consumption after the cold reservoir has been initially chilled.

### Control Unit Examples

Referring again to FIG. 3A, the above sections describe the physical systems which transfer, chill and pressurize water, pressurize gas, move and puncture the capsule, and control valves to direct flow of the water and gas. These actions may be automatically controlled by computerized systems to enact the desired result. A control and power system 342 may be provided in the form of electronics, sensors and actuators.

It may be useful to use various sensors in the system as described herein. Sensors can detect such signals as, but not limited to, the temperature of the cold sink; the temperature of the water in the cold water reservoir such as a thermometer; the level of both the warm and cold water reservoirs such as a float sensor; the presence of a capsule in the capsule holder such as a proximity sensor, photo-interrupter, reflective sensor or camera; the pressure of the air reservoir such as a piezoelectric sensor, aneroid barometer pressure sensors, manometer pressure sensors, bourdon tube pressure sensors, vacuum (Pirani) pressure sensors, sealed pressure sensors, and strain gauge pressure sensors to sense pressure within the capsule, nitrogenation chamber, or any of the piping or tanks; the position of the capsule relative to the capsule connector such as a proximity sensor, flowmeters throughout any or all of the piping or valves or chambers,. These sensors have been described above and may be used in any combination or permutation.

The control and power system 342 may accept inputs from a user, in the form of switches or sensors, computer commands, in any shape or form through for example a user interface 130 as shown in FIG. 1B. These inputs may allow selections of device options, such as the type or quantity of a beverage. Indicators may provide feedback to the user in the form of LEDs, audio signals or graphics to provide information or confirmation to the user.

A control and power system 342 can provide power to the control system and to various electrical devices in the system, such as motors, fans, valves, pumps and coolers. A dedicated power supply may be provided for the thermoelectric coolers 333, which may require substantial sustained power over a wide range of voltage and current as befits their particular function. In keeping with the goal to minimize power consumption an efficient power supply can be used.

In some example systems, a mechanism may be activated to drive a new capsule onto the capsule connector to puncture the capsule and establish fluid connections as described in FIGS. 5A-5I. Optionally, the capsule connector may be driven to partially engage the capsule, such that a seal engages with sealing surface on the capsule closure. Nitro valve 624 in FIG. 6 may be opened by automated or computerized command to begin pressurizing the space between capsule connector and the capsule closure. A pressure sensor may monitor the pressure in this space and be used to detect leaks. When this leak check is complete, the capsule, carried by the capsule carrier, may be driven downward to then puncture the capsule closure as described herein including FIGS. 5A-5I.

### Nitrogenation System Examples

As described above, the system is configured to inject both a stream of cold water but also jet of gas a into the capsule chamber for mixing the gas-infused liquid. As shown in FIG. 1A the gas reservoir 606 may be in communication with the capsule connector 118 for use in the systems and methods described herein.

Such a system may allow for the creation of persistent bubbles that utilize the presence of substances which can form a film. These can include lipids (fats), oils, proteins, polypeptides, surfactants, emulsifiers, etc. These substances naturally occur in many beverages or could be added to enable a desired result.

As described, there is a natural physical limit to the amount of a gas that can be dissolved into a liquid and, consequently, released as bubbles when it is depressurized. This finite amount is entirely insufficient to achieve desired nitrogenation.

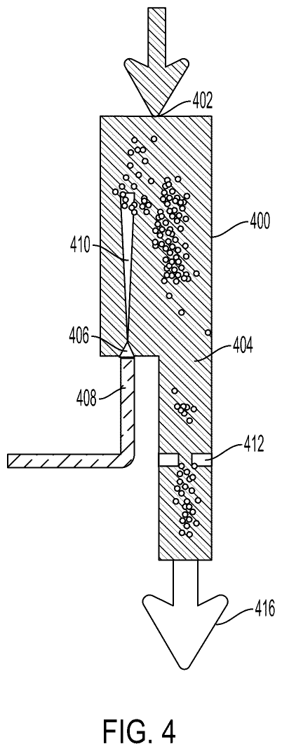

FIG. 4 is a schematic showing an example nitrogenation process that may take place for example within the replaceable capsule of the systems described herein. The chamber 400 can include a liquid under pressure. In a first example embodiment, the chamber 400 is formed within the replaceable capsule. In another example embodiment, the chamber 400 is part of the device that is configured to create a sealed connection to the capsule to generate the gas-infused liquid as described herein.

In some examples, the gas-infused liquid may be coffee concentrate or another concentrated beverage. In some examples, the pressure may be between 30 psi and 80 psi, for example. The chamber 400 may include a liquid entrance 402 and a liquid chamber 404, such that the liquid can flow continuously. The liquid entering the chamber, for example, the cold water as described above, may be forced into the chamber under pressure in order to maintain the high internal pressure within the chamber. In some examples, the chamber may be shaped to prevent trapped volumes or eddies and to encourage turbulent flow. As shown in the example an orifice 406 may be connected to a pressurized gas source 408 (e.g., from gas reservoir 606 in FIG. 1A) may be disposed to inject a fine jet of a gas 410 (such as nitrogen or ambient air) into the liquid in chamber 400. Orifice 406 may be of a very small size: for example, but not limited to, 0.1 mm or 0.2 mm in diameter where the gas comes out. The orifice 406 may be fashioned of a hydrophobic material (Polyether ether ketone (PEEK)), for example, and may have a length sufficient for surface tension (3 mm, 2 mm, etc.) to resist the entry of aqueous liquids. The chamber 400 and jet 410 of gas bubbles that come from the pressurized gas from the orifice 406, may be positioned such that the jet of gas 410 can penetrate fully into the liquid in the chamber 404 such that the gas jet 410 may be fully entrained into the moving liquid without first impacting the walls of the chamber 400. The dispense 416 may include a flow restrictor 412 such as an orifice may allow for a higher pressure to be maintained in the chamber 400 and a substantially lower pressure results in the dispensing 416 than in the chamber 400. The flow restrictor 412 may have holes or an orifice in it having a dimension of, for example, 2 mm or 2.5 mm or another size.

This arrangement may produce very small bubbles using multiple processes. As the gas jet 410 is injected into the pressurized liquid, the jet 410 may be fragmented by the turbulent flow conditions (e.g., a Reynolds number in excess of 3500) to generate a continuous stream of bubbles. The turbulence in the chamber 400 may prevent the bubbles from coalescing. The high pressure may promote dissolution of the bubbles into the liquid concentrate in the chamber 400. This resulting multiphase flow of bubbles-within-liquid may then exit the chamber through the flow restrictor 412. The flow through this restrictor 412 may cause a condition of simultaneous decompression, acceleration, increased turbulence and high liquid shear. This condition may continue to break bubbles into smaller bubbles and prevent coalescence into large bubbles. The decompression and shear condition encourages dissolved gas to come out of solution forming new bubbles. The chamber 400 may have dimensions and shape conducive to the formation and preservation of ultra-fine bubbles, and the avoidance of trapped gas pockets. For example, the chamber 400 may have sufficient length to allow gas jet 410 to fully develop and disintegrate into bubbles without encountering a wall of the chamber. This length may be 40 mm or 30 mm or another length. Likewise, the width or diameter of the chamber 400 may be sufficiently broad to permit the simultaneous injection of water, through water port 402 and gas, through nitro port 406 and the exit of the gas-infused liquid, through dispense port 404, without these flow path interfering with one another.

For example, the chamber 400 may allow the inflowing water from water port 402 to enter and mix with the concentrated liquid in the capsule chamber 400 before exiting the discharge port 404, and without performing a short-circuit to the dispense port 404. The chamber 400 may have a breadth or diameter of 20 mm or 25 mm or 30 mm or 35 mm or another size.

The shape of this chamber may be conducive to developing turbulent flow and avoiding trapped gas pockets; for example, the shape may be generally cylindrical, with rounded transitions between surfaces. The chamber 400 may also be shaped in a manner allowing for natural drainage during and after the nitrogenation process, for example, with a generally tapering transition between the main chamber 404 and the lower portion of the chamber 404. The surfaces of the chamber 400 may be generally smooth in order to shed liquids and afford rinsing. In some examples, as discussed, the chamber 400 may be a disposable and removable cartridge or capsule.

This arrangement is conducive to nitrogenating 410 a beverage or liquid concentrate in the capsule or chamber 400 using plain air as the gas. This has an example advantage of a limitless supply of gas, without need for another supply or additional components or additional waste products. This process may also be implemented using pure nitrogen as the gas. This can have an example advantage of eliminating oxygen and its oxidizing effect, and of creating a protective layer of nitrogen foam on top of a beverage.

FIG. 5A shows an example in which nitrogenation occurs in a chamber 400 connected to the capsule (for example, 112 in FIG. 1A), and in which the beverage concentrate is first combined with water and then forced into a nitrogenation chamber 400. This is a different example than when the mixing occurs within the capsule itself. Instead, in the example of FIG. 5A, the capsule is only used to supply the concentrated liquid, and not used to mix as in other example embodiments.

In the example of FIG. 5A, the capsule 502 to be used to make the beverage may be filled with liquid concentrate. A capsule connector 504 is disposed to be inserted into capsule 502, establish a sealed connection to the interior of the capsule, and to conduct liquid and gas into and out of the capsule. In an example, the capsule may be oriented such that the port or openable section is at the bottom, such that liquids may drain naturally by gravity force. Other capsule embodiments are possible, for example with fluid connections at opposite ends of the capsule such that fluids pass through the capsule (not shown).

As shown in FIG. 5A, when the capsule is placed in the example device, the capsule connector 504 may penetrate the capsule 502, exposing the liquid concentrate and establishing a seal. A water valve may be opened to expose the capsule to pressurized water 506. Dispense valve 508 may be opened to allow the pressurized cold supply water to flow into the capsule, mix with the beverage concentrate in separate chamber 404 and flow out through the dispense valve 508 via flow restrictor 412. A flow restrictor 412 at the exit of the chamber may resist this flow and consequently maintain a high pressure within the chamber. A nitro valve (624 in FIG. 6) may be opened to allow pressurized air to flow through the nitro orifice 406 and into the chamber. This example is configured to produce a jet of fine bubbles 410 in the turbulent flow within the chamber 400. As this mixture exits the chamber via the flow restrictor, further nitrogenation can occur as described above. Thusly nitrogenated, the beverage may flow into a dispensing tap 508.

FIG. 5B shows an example in which nitrogenation occurs within a beverage concentrate capsule itself and not in a separate mixing tank as described in FIG. 5A. In the example of FIG. 5B, the capsule 112 can be filled with liquid concentrate and a significant volume of head space (for example, purged with an inert gas such as nitrogen). The head space may be 25% of the total capsule volume, or another amount sufficient to be compressed when pressurized, thus allowing the introduction of the nitrogenation gas. A capsule connector 510, 612, 116, may be shaped to be inserted into the capsule 112, establish a liquid seal against the capsule, and conduct liquid and gas into and out of the capsule 112 as described herein.

Capsule carrier 114 may be shaped to accept capsule 112, and to permit its insertion and removal by a user within the overall body of the system for operation. Capsule carrier 114 may be configured to be driven by a mechanism to engage the capsule connector, the capsule carrier and mechanism capable of withstanding the hydrostatic forces created by the pressurization of the capsule. In FIG. 5B, the capsule 112 is shown already engaged with the capsule connector 510 and ready to mix and discharge.

In some examples, a water valve may be opened to expose the capsule 112 to pressurized water. Dispense valve 508 may be opened to allow the pressurized cold supply water to flow into the capsule, mix with the beverage concentrate and flow out through the dispense outlet. Similarly, opening dispense valve 508 may allow compressed gas to flow from the air pressure reservoir by way of gas line 408 through nitro orifice 406. Flow restrictor 412 may resist this flow and consequently maintain a high pressure within the capsule. The flow of gas through nitro orifice 406 may produce a jet of bubbles 410 in the turbulent flow which exit the capsule via the dispense port 404 and the flow restrictor 412.

FIG. 5C depicts an example interaction between the capsule 112 and fluidic connector 116. Capsule 112 may be forced against a fluidic connector by means of a mechanical mechanism. A seal 512 may contact sealing surface 232 or sealing surface 233 on the lid portion 204 of the capsule as described in FIG. 2B showing the capsule. In a preferred embodiment seal 512 may be movable with respect to capsule connector 116 to permit the seal 512 to form a liquid-tight connection with the capsule before further motion of the capsule. Further motion of the capsule with respect to the capsule connector may contact and puncturing of the hatch 216 as described in FIG. 2B showing the capsule as described herein.

A seal 512 may be shaped to contact the rim surface 232 of the lid portion 204 capsule as described in FIG. 2B showing the capsule. In another embodiment the seal 512 may be shaped to contact an internal surface 233 of the lid portion 204 of the capsule as described in FIG. 2B showing the capsule. In either embodiment, the seal 512 may comprise a funnel-shaped internal surface to permit the draining of liquids towards the dispense port of the capsule connector 116.

FIG. 5D shows the main elements of the capsule drive mechanism and the nitrogenation system. As shown in the example, a capsule 112 may be placed into a capsule carrier 114 which is configured to move, e.g., translate, into connection with a capsule connector 520. This movement may be accomplished by a capsule drive mechanism 414 capable of applying a high force sufficient to engage the capsule 112 with seal 512 and counteract such forces as may be created by the internal pressure of the capsule 112. The mechanism 414 may also incorporate sensors to confirm the presence of a capsule 112, the correct position of the capsule 112 and the appropriate compression of the seal. When the capsule 112 is placed in the device, the capsule 112 may be driven into engagement with the capsule connector 510 by operation of the drive mechanism 414. Seal 512 may be spring-loaded towards the capsule and positioned such that the seal engages with sealing surfaces 232 or 233 (see FIG. 2A) on the capsule lid portion prior to protrusion 520 contacting the break-out section of hatch 216 (see FIG. 2A0. As the mechanism 414 continues to drive the capsule 112 into position, protrusion 520 may break through hatch 216 (see FIG. 2A), establishing a sealed chamber between the capsule interior 112 and capsule connector 118 and releasing the contents of the capsule such as liquid concentrate. Seal 512 may become fully compressed against the body of the capsule connector with high force sufficient to maintain a liquid seal when subject to the internal pressure of the capsule 112.

The drive mechanism 414 may be a geared system that allows for automatic or manual operation of the clamping to secure the capsule 112 to the sealing device 512 and capsule connector 118. As such, because of the high forces inherent in the pressurization of the capsule 112 as described herein, and the force required to puncture the seals (as described in FIGS. 2A and 2B etc.) the drive mechanism may include a force multiplier such geared reduction, a lead screw or levers to generate high force from a compact motor. This may have the advantage of providing a higher force than could be reasonably provided by a user in a manual operation. A mechanism with high mechanical advantage may also have the advantage of being non-backdriveable (i.e. may hold a position and not retreat when subject to high applied forces, such as the hydrostatic force from a pressurized capsule). Drive mechanism 414 may comprise components of relatively high stiffness, so that said components will not deflect by an amount which could reduce the engagement with a seal on the fluidic capsule connector 118 when subject to the hydrostatic pressure of the nitrogenation system. A powered mechanism may also have the advantage of allowing a sensor to confirm a high clamping force, which may be beneficial to the correct operation of a system. A mechanical drive as described may provide high force and positive engagement of a capsule but may, by virtue of the high mechanical advantage, move at a slow speed and require an excessive amount of time to move a capsule into position. Accordingly, the motion of a capsule mechanism 414 may include in some embodiments a manually-driven portion of action and a mechanically-driven portion, said manually-driven portion being actuated by a user at a speed and time of a user's choosing, and said mechanically-actuated portion being actuated automatically and by the control system 106 according to encoded algorithms and relevant signals. Mechanism 414 may comprise sensors (for example reflective sensors, photo-interruptors, mechanical switches, force sensors, etc.) to detect the presence of a capsule, the position of a capsule within the mechanism, the position of mechanism components, the force exerted by the mechanism, or other parameters of mechanism 414. This may have the advantage of confirming correct placement of a capsule, the correct operation of the mechanism 414 and the readiness of the system to proceed with a dispensing operation.

FIGS. 5E-H illustrate an example sequence of another angle of cross-sectioned images depicting the interaction of the capsule 112 and capsule connector 520 when they may be engaged by the action of mechanism 414 to form a chamber capable of being pressurized to mix the gas and liquids as described to dispense the gas-infused liquid.

When a capsule 112 is first inserted into a device, for example by a user, the capsule 112 may be held by a capsule carrier 114 and driven by a mechanism 414 (from FIG. 5D). In some embodiments, the initial insertion of a capsule 112 (for example, by a user) may be in a transverse direction, perpendicular to an axis of the capsule, such that the inserted capsule may be thereafter constrained from moving relative to a capsule carrier 114 in an axial direction. In some embodiments, the mechanism may move in a linear direction parallel to the axis of the capsule 112.

The drive mechanism (414 from FIG. 5D) may have both or either a manually-actuated motion and a mechanically-driven motion as described above. This can allow a user clear access to insert a capsule, for example into a capsule carrier, and move a capsule carrier into close engagement with a capsule connector.

As mentioned above, an axisymmetric form such as a cylinder of the cartridge can have the advantage of not requiring a specific orientation when inserted into a dispensing device. Any orientation of the capsule in regards to the connector when driven together may be arranged, such that a user would not have to worry about spinning the capsule to line up correctly. Any angle of the hinge and force concentrator would still work in operation with the connector as shown in FIGS. 5C and 5E-5H because the force concentrator 224 in FIG. 2A-2B provides a surface that can contact and interact with the capsule connector and pop open or otherwise unseal the cartridge when in operation as described.

As shown in FIG. 5E, a capsule 112 has been positioned in a capsule carrier 114 and this combination brought into close proximity to the capsule connector 520 before the hatch is broken or opened by the connector. Further, in FIG. 5F, the capsule 112 has been driven or moved until contact is made between sealing surfaces of the capsule (e.g., surfaces 232 or 233 in FIGS. 2A, 2B etc.) and seal 512 on the capsule connector before it is broken or opened. Seal 512 may be held in spring-loaded connection to a fixed portion of the capsule connector, while protrusion 520 remains stationary.

In FIG. 5G, the capsule can continue to be driven into contact with the capsule connector, when protrusion 520 may come into contact with the raised section 224 of the lid portion 204 of the capsule 112. In FIG. 5H, the force of this contact may increase until groove 220 of the lid portion 204 breaks as described herein, causing hatch 216 to open inward (see FIGS. 2A, 2B etc), exposing the liquid contents of the capsule and creating a sealed chamber between the capsule 112 and the fluidic capsule connector 118. The motion of the capsule 112, as held by the capsule carrier and driven by mechanism 414, may cause the spring-loaded seal to come into contact with a hard-stop on the stationary portion of the capsule connector. A small amount of subsequent motion of the capsule may then compress the seal, forming a very tight seal against the sealing surfaces of the capsule. In some examples, the capsule is driven onto the capsule connector as described, but in other examples, the capsule may remain stationary and the capsule connector may move to puncture the lid and create the mixing chamber as described.

FIG. 5I illustrates an example isometric view of a portion of the fluidic capsule connector without the capsule. Water entrance port 406, gas entrance port 402 and dispense port 404 can be seen arranged on the protrusion 520 of the capsule connector, in a manner consistent with the desired mixing of beverage concentrate, water and gas as described herein. Connections to fluid lines 408 and 506 can be seen at another end of the capsule connector.

FIG. 5J depicts an example dispensing tap that may be used in the systems as described herein to further condition a beverage and direct it into a beverage vessel. A gas-infused beverage created in a mixing chamber as described may contain undesirable air pockets and/or be dispensed from an irregular manner. As it is a stated objective to maximize the fine texture of the suspended bubbles and resulting layer of foam on a beverage, it is desirable to prevent degradations in flow during final dispense. A dispensing tap may perform this function while directing the flow from the dispense port 404 of the capsule connector 118 into a drinking vessel 122.

A dispensing tap 120 may include a nozzle 125 into which may be fitted a restrictor plate 127. This restrictor plate 127 may contain one or more orifices configured to allow the flow of a gas-infused beverage, including fine bubbles as described herein, arrest or retard the passage of large bubbles or air pockets (for example, of size greater than 0.5 mm) and create a final condition of liquid shear which may fragment larger bubbles and thus create finer bubbles. The dispense tap 120 may also comprise a flow regulator 126 which may serve to mitigate fluctuations in flow volume and thus prevents disturbance to the dispensed beverage and overlying foam.

### Fluidic System Examples

As described above, the dilution and nitrogenation of a desired liquid concentrate can use the flow of introduced water and pressurized gas into a mixing chamber to generate a gas-infused liquid beverage under controlled conditions of flow and pressure.

FIG. 6 shows the elements of an example fluidic system 600 arranged to provide these conditions as described herein. As previously discussed, a cold reservoir 616 can provide a supply of chilled water. Water can be drawn from this reservoir and into a measurement chamber 604 of specific volume. This can have the advantage of directly measuring an appropriate volume of water with which to dilute a liquid beverage concentrate to produce a particular dispensed beverage.

Simultaneously controlling water flow, measurement and pressure is inherently difficult. As an example solution, an air pressure reservoir 606 may be used to pump the previously apportioned water in the measurement chamber 604. This has the further advantage of utilizing a single air pump for multiple purposes. This air reservoir 606 can be pressurized, using an air pump 608 and valve 610, until it reaches a required working pressure. When the system is requested to dispense a beverage, air valve 610 may be opened, and water valve 612 may be opened, at which time the pressurize air may drive the previously measured portion of water out of measurement chamber 604 through the capsule connector during the dispensing operation. This has the further advantage of purging the fluidic system of residual water at the conclusion of a dispensing operation. The pressure in the combined air and water chambers may naturally decrease during the dispensing operation, but the initial high pressure of the air reservoir can be selected to provide a suitable starting and finishing pressure in accordance with the needs of the dispensing and nitrogenation system.

The warm water or room temperature water reservoir 602 containing water at an ambient temperature can be pumped into a cold-water reservoir 616 via pump 618. A second pump 620 can pump water from reservoir 616 to a measurement chamber 604. This transfer flow may proceed via a 3-way valve 622. Pump 620, in combination with valve 622 may also serve to recirculate cold water withing cold reservoir 616 as described above. Further, a gas such as nitrogen can flow to a gas entrance port 406 via a valve 624. An dispense port 508 can output an output liquid to a dispense tap 120.

When a beverage of a particular type is to be dispensed, a measured volume of water may be withdrawn from the cold reservoir 616 and pumped to a measurement chamber 604. This can have an example advantage of portioning a controlled volume suited to the desired beverage preparation and isolating the remainder of the cold reservoir from the dispensing process. The portion of water may be measured by flow control of the water pump, by sensors configured to detect any number of optional volumes, or by the fixed capacity of the chamber 604, or by another method.

While the measured volume of water has been moved into the measurement chamber, the air pump 608 may be activated and air valve 610 closed to pressurize the reservoir 606.

After the capsule is breached, water valve 612 may be opened to connect the air reservoir to the measurement chamber. Because the measurement chamber is pressurized, water can be forced through the capsule connector 118 and into the capsule. Nitro valve 624 may also be opened to allow pressurized gas to flow through the nitro jet orifice. The dispense valve may also be opened to permit flow to pass through the capsule connector and through the flow restrictor. As described above, the flow restrictor 412 can have the primary function of resisting flow and thereby maintaining an elevated pressure in the capsule, for example, by having a smaller orifice or opening than the chamber. This flow restrictor 412 may have an example advantage of maintaining a high local pressure in the liquid into which gas is injected by the nitro jet of gas. In examples where the dispense valve is open, the beverage can pass through the flow restrictor under high pressure and high velocity. If a nitrogenated beverage is selected, the flow through the flow restrictor can cause high turbulence and high shear conditions which may produce additional bubbles as well as shearing existing bubbles into smaller bubbles.

The beverage can then continue to flow, under the remaining system pressure as well as gravity, through the flow restrictor 412, continuing on out of the dispensing tap 120. This flow will continue under the trapped pressure of the air reservoir, until all the water in the measurement chamber has been expelled.

As water and gas are forced into the capsule 112, they can both combine with the liquid concentrate and drive this resulting mixture out through the dispense port 404 in FIG. 5I. As fresh water continues to enter the capsule, the capsule contents may continuously decrease in concentration. By the time the last of the measured water enters the capsule, the liquid concentrate may have largely been flushed out, leaving only faint residue. Pressurized air may continue to flow into the capsule through both the water inlet port and the nitro jet orifice and can flow relatively unimpeded out through the flow restrictor and the dispensing tap 120. This has the advantage of purging the fluidic components of residual liquid and reducing the potential for accumulation, clogging or transfer of residual flavor to subsequent beverages.

After a prescribed period of this purging with first water and then gas, the dispense valve 120 may be closed, thus terminating the dispensing process and preventing any further drainage into a receptacle. In an example, the dispense valve may divert residual flow into an alternate drain path for disposal.

At this point, the dispensing may be considered complete. The water valve 612 and nitro valve 624 may be closed to relieve the pressure on the measurement chamber. When the pressure is relieved, the capsule connector mechanism may be activated to disconnect from the capsule (disengaging the capsule connector and seal). The capsule may now be removed from the system.

A portion of cold water having been withdrawn from the cold reservoir, valves and/or pump 618 may be activated to transfer water from the warm reservoir 602 to the cold reservoir 616. As described above, the control system in conjunction with temperature and water-level sensors may command the cooling system to chill the contents of the cold reservoir to the required temperature.

Pump 620 may be combined with a valve 622 which may permit the recirculation of cold water through the cold tank 616. This can have the advantage of mixing the chilled water and preventing excessive cooling and possible freezing of water in contact with the cooling elements.

In another example dispensing operation, alone or in combination, when a non-nitrogenated beverage is desired and a suitable user selection has been made, the above process can be repeated with the exception of omitting the nitrogenation air input. In this still beverage mode, nitro valve 624 would remain closed during the dispensing operation. The chilled water would be measured and forced through the capsule in the same manner as previously described. This non-nitrogenated beverage may also be dispensed at reduced pressures, to reduce turbulence and the entraining of air and thus minimize creation of foam.

In yet another example dispensing operation, a beverage of different concentration may be dispensed. In this mode, a different volume of chilled water may be measured into the measurement chamber 604, and then the dispensing operation may proceed as above. Any kind of concentrated material may be used in the systems and methods described herein to impart nitrogenation as described and the example of coffee is not intended to be limiting.

### Computer and Computer Network Examples

In example systems described herein, various computing components may be utilized to operate the systems including turning component parts such as pumps and compressors on and off, opening valves and dispensing the beverages. These may be accomplished by automated parts in communication with computer components to send and receive message to the automated parts. In some examples, alternatively or additionally, the system may be networked for control or data storage purposes linked by communication systems such as but not limited to a WiFi system/cellular system/Bluetooth system, or any other communication system, with the appropriate antenna system and a processor and memory as described herein, may be used on a subassembly. In some embodiments, alternatively or additionally, the hardware may include a single integrated circuit containing a processor core, memory, and programmable input/output peripherals.

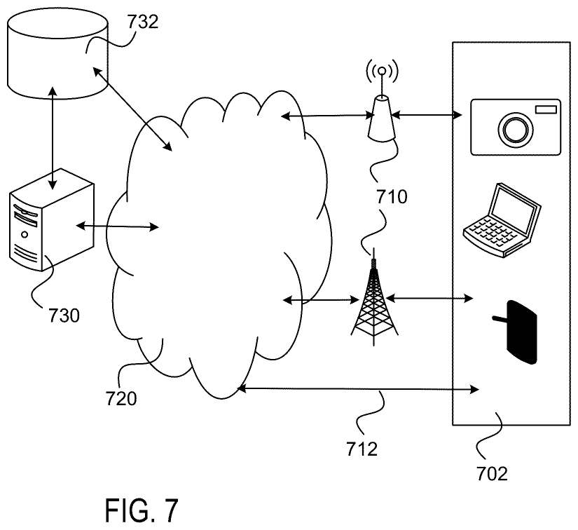

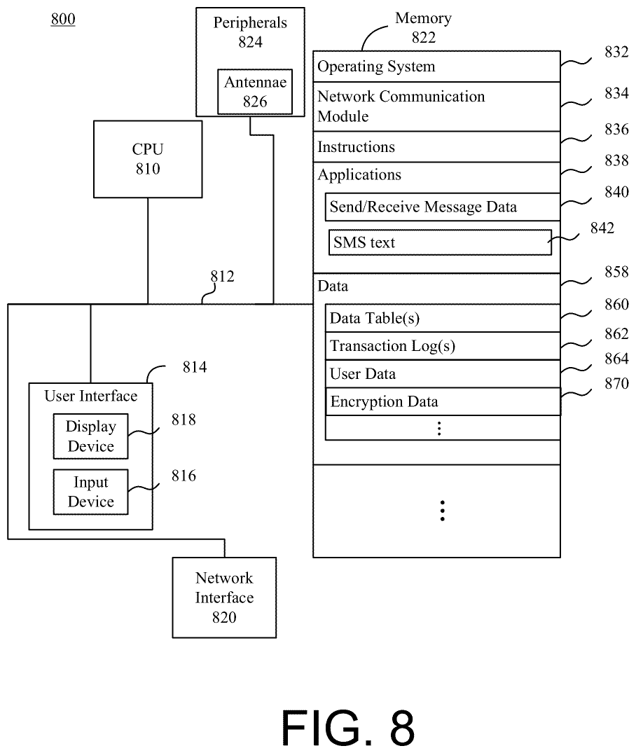

FIG. 7 shows an example networked system which could be used in the systems and methods here. In FIG. 7, the computer system 702 described herein, including process any images from the various sensors including cameras taking images of the beverage cup or capsules or dispensing component parts. Such image data may include pixel data of the captured images. The computer 702 could be any number of kinds of computers such as those included in the camera itself, automated valves, pumps, systems, proximity sensor systems, and/or any other another computer arrangement including those examples are described in FIG. 8.

As shown in FIG. 7, the various computing systems may be in communication with a back-end computing system 730 and/or data storage 732 to send and receive data as described herein. For example, as shown in FIG. 7, captured image data may be transmitted to a back-end computer system 730 and associated data storage 732 for saving and analysis. In some examples, the communication may be a wireless transmission 710 by a radio, cellular or WiFi transmission with associated routers and hubs. In some examples, the transmission may be through a wired connection 712.

In some examples, the transmission of data may include transmission through a network such as the internet 720 to the remote operators, back-end server computers 730, and associated data storage 732.

FIG. 8 shows an example computing device 800 that may be used in practicing example embodiments described herein. FIG. 8 could describe computers such as 702, 730 or other systems as described in FIG. 7. In FIG. 8, the computing device could be a smartphone, a laptop, tablet computer, server computer, or any other kind of computing device. The example shows a processor CPU 810 which could be any number of processors in communication via a bus 812 or other communication with a user interface 814. The user interface 814 could include any number of display devices 818 such as a screen. The user interface also includes an input such as a touchscreen, keyboard, mouse, pointer, buttons, joystick or other input devices. Also included is a network interface 820 which may be used to interface with any wireless or wired network in order to transmit and receive data. Such an interface may allow for a smartphone, for example, to interface a cellular network and/or WiFi network and thereby the Internet. The example computing device 800 also shows peripherals 824 which could include any number of other additional features such as but not limited to cameras, sensors 825, and/or antennae 826 for communicating wirelessly such as over cellular, WiFi, NFC, Bluetooth, infrared, or any combination of these or other wireless communications. The computing device 800 also includes a memory 822 which includes any number of operations executable by the processor 810. The memory in FIG. 8 shows an operating system 832, network communication module 834, instructions for other tasks 838 and applications 838 such as send/receive message data 840 and/or SMS text message applications 842. Also included in the example is for data storage 858. Such data storage may include data tables 860, transaction logs 862, user data 864 and/or encryption data 870. The computing device 800 also include one or more graphical processing units (GPUs) for the purposes of accelerating in hardware computationally intensive tasks such as execution and or evaluation of the neural network engine and enhanced image exploitation algorithms operating on the multi-modal imagery collected. The computing device 800 may also include one or more reconfigurable hardware elements such as a field programmable gate array (FPGA) for the purposes of hardware acceleration of computationally intensive tasks.

### Conclusion

As disclosed herein, features consistent with the present inventions may be implemented by computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as 1PROM), embedded microprocessors, Graphics Processing Units (GPUs), firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks by one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. Etc.

What is claimed is:

1. A device comprising:
a cold water tank;
a cooling system configured to chill an input amount of water and maintain a temperature of cold water held in the cold water tank;
a gas reservoir configured to contain an amount of a pressurized gas; and
a fluidic capsule connector configured to create a gas-infused liquid, the fluidic capsule connector comprising:
a capsule connector configured to connect to a capsule and establish a pressurized chamber in a cavity of the capsule that is removably connected to the capsule connector;
a liquid entrance port connected to the capsule connector and configured to provide a stream of cold water from the cold water tank and create turbulent conditions in the pressurized chamber; and
a gas entrance port connected to the gas reservoir and configured to provide a jet of the gas and introduce a stream of fine bubbles to the pressurized chamber, wherein a gas-infused liquid is formed by mixing a liquid concentrate from the capsule with the cold water and the gas in the pressurized chamber;
a dispense port configured to direct a flow of the gas-infused liquid from the pressurized chamber to a dispensing tap;
one or more temperature sensors disposed in the cold water tank;
a heat exchange component extending within the cold water tank, configured to transfer heat from a cold side to a hot side of the heat exchange component.

2. The device of claim 1, further comprising:
an input reservoir accessible outside of the device and configured to receive input water;
a pump configured to pump the input water from the input reservoir to the cold water tank, wherein the cold water tank is insulated with an insulating material; and
one or more liquid level sensors disposed in the cold water tank;

3. The device of claim 1, wherein the heat exchange component includes two thermoelectric coolers arranged adjacent to one another.

4. The device of claim 1, wherein the capsule connector comprises a protrusion extending from the capsule connector to break a knockout element in the capsule and create the pressurized chamber between the fluidic capsule connector and the cavity formed in the capsule.

5. The device of claim 1, further comprising:
an air valve disposed adjacent to the gas reservoir; and
a water valve disposed between the gas reservoir and the cold water tank, wherein, at a time of dispensing, the air valve is closed and the water valve is opened to drive a pressurized mixture of gas and cold water into the pressurized chamber via a liquid entrance valve.

6. The device of claim 1, wherein the gas includes nitrogen.

7. The device of claim 1, wherein the fluidic capsule connector further includes a flow restrictor disposed adjacent to the dispense port, the flow restrictor controlling a flow of the gas-infused liquid entering the dispense port.

8. The device of claim 1, wherein the capsule comprises:
a main body comprising a cavity and the liquid concentrate in the cavity; and
a lid portion comprising a hatch with a knockout element disposed on an outer surface of the lid portion.

9. The device of claim 8, wherein the lid portion is affixed to the main body using a crimp ring formed around the lid portion.

10-13. (canceled)

14. A system comprising:
a capsule containing a liquid concentrate, the capsule comprising:
a main body comprising a cavity and the liquid concentrate in the cavity; and
a lid portion comprising a hatch with a knockout element disposed on an outer surface of the lid portion; and
a device for generating a gas-infused liquid, the device comprising:
a cold water tank;
a cooling system configured to chill an input amount of water and maintain a temperature of cold water held in the cold water tank;
a gas reservoir containing an amount of a gas; and
a fluidic capsule connector configured to create a gas-infused liquid, the fluidic capsule connector comprising:
a capsule connector configured to connect to the capsule and establish a pressurized chamber in a cavity of the capsule;
a liquid entrance valve connected to the capsule connector and configured to provide a stream of cold water from the cold water tank and the gas from the reservoir to the pressurized chamber, wherein a gas-infused liquid is formed by mixing a liquid concentrate from the capsule with the cold water and the gas in the pressurized chamber;
a dispense port configured to direct a flow of the gas-infused liquid from the pressurized chamber to a dispensing tap;
one or more temperature sensors disposed in the cold water tank; and
a heat exchange component extending within the cold water tank, wherein the heat exchange component is configured to receive one or more thermoelectric coolers configured to transfer heat from a cold side to a hot side of the heat exchange component.

15. The system of claim 14, further comprising:
an input reservoir accessible outside of the device and configured to receive input water;
a pump configured to pump the input water from the input reservoir to the cold water tank, wherein the cold water tank is insulated with an insulating material;

16. The system of claim 14, wherein the heat exchange component includes two thermoelectric coolers arranged adjacent to one another.

17. The system of claim 14, wherein the capsule connector extends from the capsule connector to break a knockout element in the capsule and create the pressurized chamber between the fluidic capsule connector and the cavity formed in the capsule.

18. The system of claim 14, further comprising:
an air valve disposed adjacent to the gas reservoir; and
a water valve disposed between the gas reservoir and the cold water tank, wherein, at a time of dispensing, the air valve is closed and the water valve is opened to drive a pressurized mixture of gas and cold water into the pressurized chamber via the liquid entrance valve.

19. The system of claim 14, wherein the gas includes nitrogen.

20. The system of claim 14, wherein the fluidic capsule connector further includes a flow restrictor disposed adjacent to the dispense port, the flow restrictor controlling a flow of the gas-infused liquid entering the dispense port.
